(19) United States
(12) Patent Application Publication
(10) Pub. No.: US 2009/0227409 A1
(43) Pub. Date: Sep. 10, 2009

(54) CONTROL DEVICE AND CONTROL METHOD FOR VEHICLE

(75) Inventors: Masatoshi ITO, Okazaki-shi (JP); Taiyo Uejima, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/390,864

(22) Filed: Feb. 23, 2009

(30) Foreign Application Priority Data
Mar. 4, 2008 (JP) 2008-053374

(51) Int. Cl. B60W 10/04; B60K 1/02; B60W 20/00

(52) U.S. Cl. 475/5; 477/3; 180/65.275

(57) ABSTRACT

During downshifting, a control for restricting an output of an engine to constantly maintain electric power balance between a first electric motor and a second electric motor or a control for suppressing a rate of increase in engine rotational speed by a control on the engine, such as ignition timing retardation control or fuel injection amount reduction control, is executed to thereby allow torque of the second electric motor to be reduced during downshifting. In addition, the engine rotational speed is decreased before downshifting, and, after the engine rotational speed is decreased to a rotational speed at which a protection control is not activated, an automatic transmission downshifts. With the above control, it is possible to suppress an increase in rotational speed of the second electric motor during downshifting. Thus, shift shock may be suppressed, and the friction material of the frictional engagement element may be protected.

### INCORPORATION BY REFERENCE

The disclosure of Japanese Patent Application No. 2008-053374 filed on Mar. 4, 2008 including the specification, drawings and abstract is incorporated herein by reference in its entirety.

### BACKGROUND OF THE INVENTION

1. Field of the Invention

The invention relates to a control device and control method for a vehicle equipped with a differential unit that outputs at least portion of power from an engine to driving wheels; a first electric motor coupled to a rotating element of the differential unit; and a second electric motor, wherein power from the second electric motor is output through a step-gear automatic transmission to the driving wheels.

2. Description of the Related Art

In recent years, in terms of environmental protection, it is desired to reduce exhaust gas emissions from an engine (internal combustion engine) mounted on a vehicle and to improve a specific fuel consumption (fuel economy), and a hybrid vehicle equipped with a hybrid system is widely used as a vehicle that satisfies these requests.

The hybrid vehicle includes an engine (for example, a gasoline engine or a diesel engine) and an electric motor (for example, a motor generator or a motor) that generates electric power using power output from the engine or is driven by electric power from a battery to assist the engine to output power. The hybrid vehicle uses the engine or the electric motor or both as a driving source.

In the hybrid vehicle, the operating ranges (specifically, drive or stop) of the engine and electric motor are controlled on the basis of a vehicle speed and an accelerator operation amount. For example, in a range in which the efficiency of the engine is low, such as at startup or during low-speed running, the engine is stopped, and the driving wheels are driven only by power from the electric motor. In addition, during normal running, the hybrid vehicle executes a control such that the engine is driven to drive the driving wheels by power from the engine. Furthermore, during high-load operation, such as full acceleration, the hybrid vehicle executes a control such that, in addition to power from the engine, electric power is supplied from the battery to the electric motor to add power from the electric motor as assist power.

One of driving systems for the above described hybrid vehicle is, for example, known as a vehicle driving system, which is, for example, described in Japanese Patent Application Publication No. 2006-316848 (JP-A-2006-316848). The vehicle driving system includes a power distribution mechanism; a second electric motor; a step-gear automatic transmission; and an electric storage device (battery). The power distribution mechanism has a sun gear, a ring gear and a carrier (pinion gears) as rotating elements, and distributes power from an engine to a first electric motor and a transmission shaft (ring gear shaft) (or outputs the resultant power of power from the engine and power from the first electric motor to the transmission shaft). The automatic transmission is provided between the second electric motor and driving wheels (output shaft). The electric storage device is able to store electric power generated in the first and/or second electric motors and to supply electric power to the first and/or second electric motors. Then, power from the second electric motor is output through the automatic transmission to the driving wheels (axles).

In the above vehicle driving system, the power distribution mechanism operates as a differential mechanism. The power distribution mechanism uses differential action to mechanically transmit the major portion of power from the engine to the driving wheels and to electrically transmit the remaining portion of power from the engine through an electrical path from the first electric motor to the second electric motor. Thus, the power distribution mechanism operates as a transmission that electrically changes the gear ratio. By so doing, it is possible to allow the vehicle to run while maintaining the engine in an optimal operating state and, therefore, fuel economy may be improved. In addition, in the driving system for this type of hybrid vehicle, the balance of electric power is normally controlled so that the sum of the amount of electric power generated by the generator, the amount of electric power charged to and discharged from the battery, and the amount of power consumed by the motors is zero.

On the other hand, the transmission mounted on the hybrid vehicle employs a planetary gear transmission that uses clutches and brakes (frictional engagement elements) and a planetary gear set to set a gear. For example, two brakes are provided as fictional engagement elements to shift a gear between a gear (for example, low-speed gear) in which one of the brakes is engaged and the other one of the brakes is released and a gear (for example, high-speed gear) in which the other one of the brakes is engaged and the one of the brakes is released. In this case, a so-called clutch-to-clutch shifting is performed during shifting. In the clutch-to-clutch shifting, an engaging frictional engagement element is engaged and a releasing frictional engagement element is released at the same time.

In addition, a vehicle such as a hybrid vehicle is equipped with a shift operating device that is operated by the driver. The driver is able to change the shift position of an automatic transmission to, for example, P (parking) position, R (reverse) position, N (neutral) position, D (drive) position, or the like, by operating a shift lever of the shift operating device. Furthermore, in recent years, a shift operating device having a sequential mode is also widely used. The sequential mode has a plurality (for example, six) of set sequential shift ranges. When the shift lever is at S (sequential) position and then the driver operates the shift lever to an upshift (+) position or to a downshift (−) position, the sequential shift range upshifts or downshifts. Then, when the above sequential mode is selected, the engine rotational speed is maintained at a speed higher than that during running in a D range.

Note that as a technique related to a control during shifting in a hybrid vehicle, Japanese Patent Application Publication No. 2006-316848 (JP-A-2006-316848) describes that, in a hybrid vehicle that outputs power from a second electric motor through an automatic transmission to driving wheels (axles), torque of the second electric motor is reduced at the time when the automatic transmission downshifts.

Incidentally, in the above described hybrid vehicle, when an accelerator pedal is depressed during downshifting, it is necessary to reduce torque of the second electric motor in order to reduce shift shock and to reduce a thermal load, or the like, on a friction material of a frictional engagement element (brake) of the automatic transmission. However, when the engine operates at a high rotational speed, a protection control (engine overrun prevention control) is activated and, as a result, torque of the second electric motor cannot be reduced. That is, when the engine rotational speed is low, an engine power may be consumed by increasing the engine rotational speed. However, when the engine rotational speed is high, such as when the above described sequential shift is used, a rotational speed control is executed in the first electric motor (generator) that provides counter force against engine torque for engine overrun prevention (components protection). Thus, the amount of electric power generated by the first electric motor increases. As the amount of electric power generated by the first electric motor increases in this way, the second electric motor (motor) is required to consume electric power and, therefore, cannot reduce the torque desirably.

Then, when the torque of the second electric motor cannot be reduced during downshifting because of the above reason, an increase in rotational speed of the second electric motor, which is associated with gear shifting, cannot be restricted. Thus, the frictional engagement element is engaged in a state where there is a difference between the rotational speed of the second electric motor and the engagement target rotational speed (synchronous rotational speed of a target gear). This may produce engagement shock. In addition, a thermal load on the friction material of the frictional engagement element may increase.

Note that if the battery has a sufficient capacity and is able to sufficiently accept electric power, the above problem may be eliminated. However, to ensure the capacity that allows charging of electric power in any conditions, including charging of the amount of electric power generated by the first electric motor when the engine is rotated at a high speed, or the like, the specification of the battery becomes excessive and, therefore, it is difficult to implement such a battery.

In addition, in a hybrid vehicle, techniques for canceling variations in driving force during shifting by a cooperative control between a motor (generator) and an engine are disclosed; however, even with these techniques, the cooperative control may not be executed during shifting because of components protection control, or the like. Thus, shift shock may occur and a thermal load on the friction material may increase.

### SUMMARY OF THE INVENTION

The invention provides a control that is able to suppress occurrence of shift shock and an increase in thermal load on a friction material of a step-gear automatic transmission during downshifting in a control device and control method for a vehicle that includes a differential unit that outputs at least portion of power from an engine to driving wheels; a first electric motor coupled to a rotating element of the differential unit; and a second electric motor, wherein power from the second electric motor is output through the automatic transmission to driving wheels (axles).

A first aspect of the invention provides a control device for a vehicle that includes: an engine; a differential unit that is provided between the engine and driving wheels and that outputs at least portion of power from the engine to the driving wheels; a first electric motor that is coupled to a rotating element of the differential unit; a second electric motor; a step-gear automatic transmission that is provided between the second electric motor and the driving wheels (axles); and an electric storage device that is able to charge electric power generated by at least one of the first and second electric motors and supply electric power to at least one of the first and second electric motors. The control device for a vehicle according to the first aspect includes an engine control unit that restricts an output of the engine (engine power) so that electric power balance is maintained between the first electric motor and the second electric motor when the automatic transmission is downshifting.

In the first aspect of the invention, the amount of electric power generated by (the power generation amount of) the first electric motor that controls the rotational speed of the engine is taken into consideration, and the output of the engine is restricted so that electric power balance is constantly maintained between the first electric motor and the second electric motor during downshifting. Specifically, the output of the engine is restricted so that, during downshifting, the power generation amount (which may include the amount of power consumed by auxiliary machines (auxiliary machine consuming amount), which will be described later) of the first electric motor falls within the electric power acceptance limit of the electric storage device. With the above output restriction control, it is possible to reduce the torque of the second electric motor during downshifting and, therefore, it is possible to suppress an increase in rotational speed of the second electric motor. By so doing, it is possible to reduce a difference between the rotational speed of the second electric motor and the engaging target rotational speed (synchronous rotational speed of a target gear) when the frictional engagement element is engaged. Thus, shift shock may be suppressed, and the friction material of the frictional engagement element may be protected.

In addition, the engine control unit may control the output of the engine during downshifting so as to be maximal within a range of the electric power balance. With this control, it is possible to satisfy a user's driving force request (accelerator depression amount) as much as possible.

In addition, the engine control unit may execute any one of or both of a control for gradually changing the output of the engine at the time when the engine control unit starts restricting the output of the engine or a control for gradually changing the output of the engine at the time when the engine control unit completes restricting the output of the engine. In this manner, when the output of the engine is gradually changed at the time when the engine output restriction is started or stopped, it is possible to suppress occurrence of shift shock at the time when the output of the engine is changed.

A second aspect of the invention provides a control device for a vehicle that includes: an engine; a differential unit that is provided between the engine and driving wheels and that outputs at least portion of power from the engine to the driving wheels; a first electric motor that is coupled to a rotating element of the differential unit; a second electric motor; a step-gear automatic transmission that is provided between the second electric motor and the driving wheels (axles); and an electric storage device that is able to charge electric power generated by at least one of the first and second electric motors and supply electric power to at least one of the first and second electric motors. The control device for a vehicle according to the second aspect includes a rotational speed control unit that decreases a rotational speed of the engine before the automatic transmission starts downshifting. In addition, the rotational speed control unit may cause the automatic transmission to start downshifting when the rotational speed of the engine is lower than or equal to a reduction target value by reducing the rotational speed of the engine before the automatic transmission starts downshifting.

According to the second aspect of the invention, because the engine rotational speed is decreased before the automatic transmission starts downshifting, even when the engine rotational speed is high, such as when the sequential shift is used, the engine rotational speed during downshifting may be decreased to a rotational speed at which a protection control (engine overrun prevention control) is not activated in the first electric motor. Thus, with the second aspect of the invention as well, it is possible to reduce the torque of the second electric motor during downshifting and, therefore, it is possible to suppress an increase in rotational speed of the second electric motor. By so doing, it is possible to reduce a difference between the rotational speed of the second electric motor and the engaging target rotational speed (synchronous rotational speed of a target gear) when the frictional engagement element is engaged. Thus, shift shock may be suppressed, and the friction material of the frictional engagement element may be protected.

Here, a reduction target value set for the engine rotational speed may be set in consideration of a rotational speed at which a protection control (engine overrun prevention control) is not activated. The protection control prevents the engine rotational speed from exceeding an allowable engine rotational speed, that is, an allowable rotational speed (see FIG. 16) that is determined on the basis of a limit rotational speed of the engine, an upper limit rotational speed of the first electric motor (MG1), an upper limit rotational speed of a rotating element (pinion gears, and the like) of a driving force transmission system, and the like.

In addition, the reduction target value that is set for the engine rotational speed may be variably set in consideration of a state in which the electric storage device (battery) accepts electric power. Specifically, in terms of the above, when the electric storage device is able to accept electric power, a margin for the engine rotational speed, at which a protection control is activated, is larger than that when the electric storage device cannot accept electric power. Thus, it is possible to set a larger reduction target value by that much. By variably setting the reduction target value in consideration of this point, it is possible to suppress a range, in which the above described engine rotational speed reduction control is applied, to a necessary minimum range.

A third aspect of the invention provides a control device for a vehicle that includes: an engine; a differential unit that is provided between the engine and driving wheels and that outputs at least portion of power from the engine to the driving wheels; a first electric motor that is coupled to a rotating element of the differential unit; a second electric motor; a step-gear automatic transmission that is provided between the second electric motor and the driving wheels (axles); and an electric storage device that is able to charge electric power generated by at least one of the first and second electric motors and supply electric power to at least one of the first and second electric motors. The control device for a vehicle according to the third aspect includes an engine control unit that suppresses a rate of increase in rotational speed of the engine by a control on the engine when the automatic transmission is downshifting.

According to the third aspect of the invention, because a rate of increase in engine rotational speed is suppressed by the control on the engine during downshifting, it is possible to cause a protection control (engine overrun prevention control) in the first electric motor not to be activated during downshifting. Thus, with the third aspect of the invention as well, it is possible to reduce the torque of the second electric motor during downshifting and, therefore, it is possible to suppress an increase in rotational speed of the second electric motor. By so doing, it is possible to reduce a difference between the rotational speed of the second electric motor and the engaging target rotational speed (synchronous rotational speed of a target gear) when the frictional engagement element is engaged. Thus, shift shock may be suppressed, and the friction material of the frictional engagement element may be protected.

In addition, the engine control unit may execute a control for suppressing a rate of increase in rotational speed of the engine when the rotational speed of the engine is higher than or equal to a determination threshold. In this case, the determination threshold that is set for the engine rotational speed may be set to a value that allows a margin for the allowable rotational speed of the engine (determination threshold=engine allowable rotational speed−margin) in consideration of the allowable rotational speed of the engine (see FIG. 16), which is determined on the basis of a limit rotational speed of the engine, an upper limit rotational speed of the first electric motor (MG1), an upper limit rotational speed of a rotating element (pinion gears, and the like) of a driving force transmission system, and the like.

In addition, the determination threshold set for the engine rotational speed may be variably set in consideration of a state in which the electric storage device (battery) accepts electric power. Specifically in terms of the above, when the electric storage device is able to accept electric power, a margin for the engine rotational speed, at which a protection control is activated, is higher than that when the electric storage device cannot accept electric power. Thus, it is possible to set a higher determination threshold by that much. By variably setting the determination threshold in consideration of this point, it is possible to suppress a range, in which the above described engine rotational speed increase suppression control is applied, to a necessary minimum range.

In addition, the control unit may execute a control for suppressing a rate of increase in rotational speed of the engine in consideration of power required for the engine during downshifting. Specifically, when the power required for the engine is large and, therefore, the engine rotational speed increases during downshifting to reach the upper limit of the allowable rotational speed (the engine rotational speed reaches the upper limit), a rate of increase in engine rotational speed may be suppressed by the control on the engine.

In this way, only when the engine rotational speed is higher than or equal to the determination threshold and/or when the power required for the engine is larger than or equal to the determination threshold, a control for suppressing a rate of increase in engine rotational speed is executed. Thus, a control for suppressing a rate of increase in engine rotational speed may be executed only if necessary and, therefore, it is possible to minimize driver's discomfort (delay of increase in rotational speed, or the like).

In addition, a method of suppressing a rate of increase in engine rotational speed may be selected from among an ignition timing retardation control on the engine, a fuel injection amount reduction control on the engine, a control for canceling a moderating process executed on a control of the engine (for example, a moderating process executed on torque restriction in the electronic throttle control), or the like. These controls may be executed alone or in combination of any two or all of the controls.

A fourth aspect of the invention provides a control method for a vehicle that includes: an engine; a differential unit that is provided between the engine and driving wheels and that outputs at least portion of power from the engine to the driving wheels; a first electric motor that is coupled to a rotating element of the differential unit; a second electric motor; a step-gear automatic transmission that is provided between the second electric motor and the driving wheels (axles); and an electric storage device that is able to charge electric power generated by at least one of the first and second electric motors and supply electric power to at least one of the first and second electric motors. The control method for a vehicle according to the fourth aspect includes: determining whether the automatic transmission is downshifting; and when it is determined that the automatic transmission is downshifting, restricting an output of the engine (engine power) so that electric power balance is maintained between the first electric motor and the second electric motor.

In the fourth aspect of the invention, the amount of electric power generated by (the power generation amount of) the first electric motor that controls the rotational speed of the engine is taken into consideration, and the output of the engine is restricted so that electric power balance is constantly maintained between the first electric motor and the second electric motor during downshifting. Specifically, the output of the engine is restricted so that, during downshifting, the power generation amount (which may include the amount of power consumed by auxiliary machines (auxiliary machine consuming amount), which will be described later) of the first electric motor falls within the electric power acceptance limit of the electric storage device. With the above output restriction control, it is possible to reduce the torque of the second electric motor during downshifting and, therefore, it is possible to suppress an increase in rotational speed of the second electric motor. By so doing, it is possible to reduce a difference between the rotational speed of the second electric motor and the engaging target rotational speed (synchronous rotational speed of a target gear) when the frictional engagement element is engaged. Thus, shift shock may be suppressed, and the friction material of the frictional engagement element may be protected.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic configuration diagram that shows an example of a hybrid vehicle according to an embodiment of the invention;

FIG. 2 is a schematic configuration diagram of an automatic transmission mounted on the hybrid vehicle of FIG. 1;

FIG. 3 is an operation table of the automatic transmission shown in FIG. 1;

FIG. 4 is a circuit configuration diagram that shows portion of a hydraulic pressure control circuit of the automatic transmission;

FIG. 5A is a view that shows a perspective view of a relevant portion of a shift operating device;

FIG. 5B is a view that shows a shift gate of the shift operating device;

FIG. 6 is a block diagram that shows the configuration of a control system, such as an ECU;

FIG. 7 is a view that shows an example of a map used to calculate a required torque;

FIG. 8 is a view that shows an example of a shift line map used for a gear shift control;

FIG. 9 is a view that shows an example of a sequential mode shift line map;

FIG. 10 is a flowchart that shows an example of an engine control during downshifting, executed by the ECU;

FIG. 11 is a view that shows the relationship between an amount of electric power generated by a first motor generator and an electric power acceptance limit of a battery;

FIG. 12 is a timing chart that shows an example of a variation in engine output power at the time of start and complete restricting an engine output power and a variation in rotational speed and torque of a second motor generator;

FIG. 13 is a timing chart that shows another example of a variation in engine output power at the time of start and complete restricting an engine output power and a variation in rotational speed and torque of the second motor generator;

FIG. 14 is a flowchart that shows an example of an engine control before downshifting, executed by the ECU;

FIG. 15 is a flowchart that shows another example of an engine control during downshifting, executed by the ECU;

FIG. 16 is a map that shows an allowable rotational speed of the engine; and

FIG. 17 is a schematic configuration diagram that shows another example of a hybrid vehicle according to another embodiment of the invention.

### DETAILED DESCRIPTION OF EMBODIMENTS

Hereinafter, an embodiment of the invention will be described with reference to the accompanying drawings.

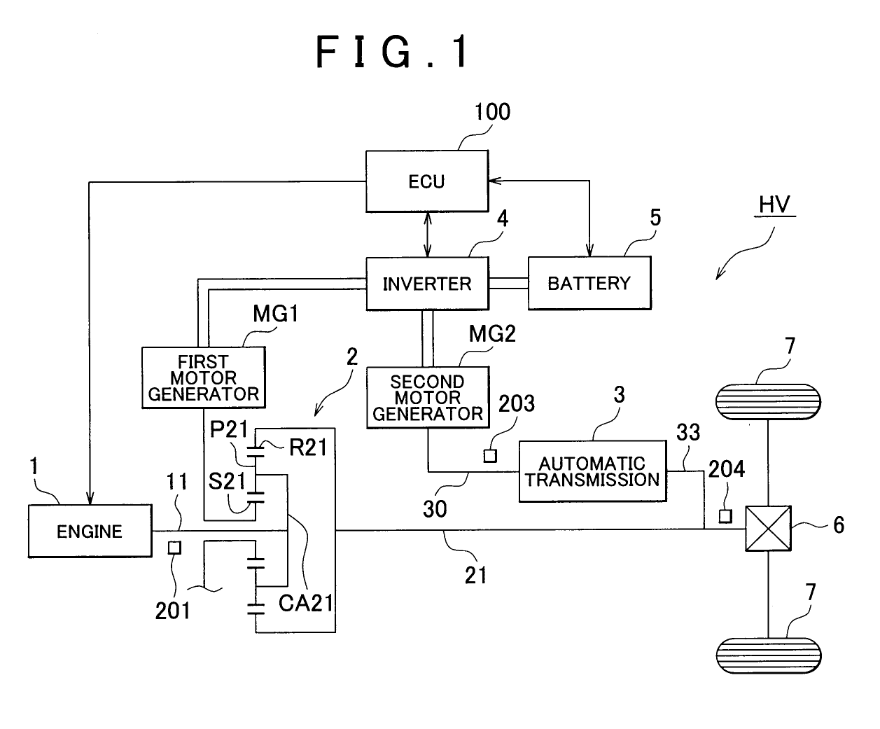

FIG. 1 is a schematic configuration diagram that shows an example of a hybrid vehicle according to the embodiment of the invention.

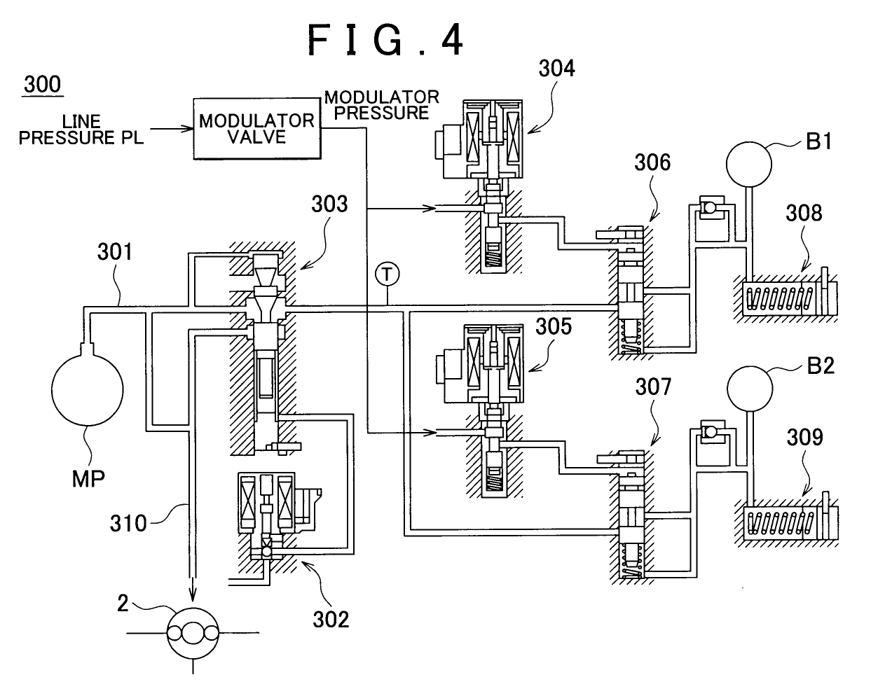

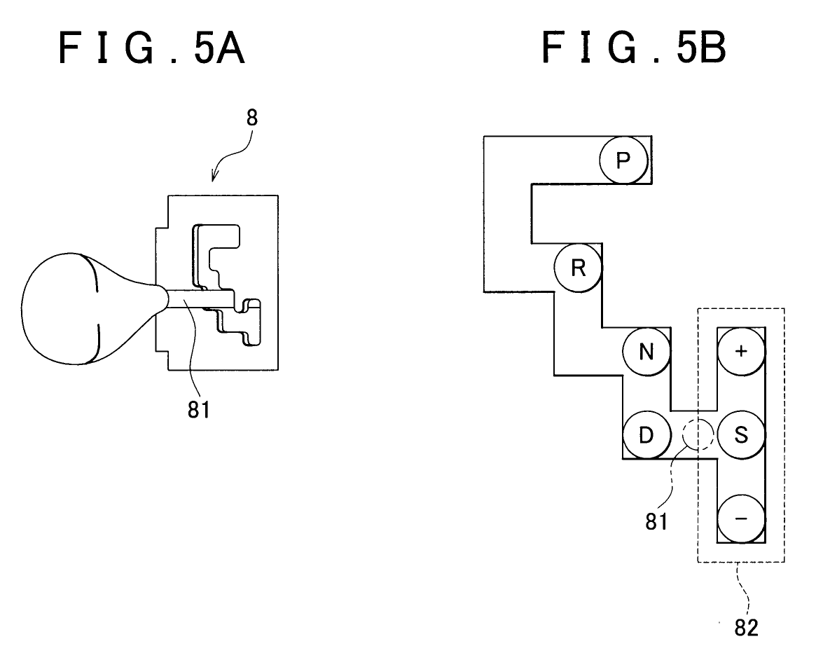

A hybrid vehicle HV in this embodiment includes an engine 1, a first motor generator MG1, a second motor generator MG2, a power distribution mechanism 2, an automatic transmission 3, an inverter 4, a battery (HV battery) 5, a differential gear 6, driving wheels 7, a hydraulic pressure control circuit 300 (see FIG. 4), a shift operating device 8 (see FIG. 5A and FIG. 5B), an electronic control unit (ECU) 100, and the like.

These engine 1, motor generators MG1 and MG2, power distribution mechanism 2, automatic transmission 3 (including the hydraulic pressure control circuit 300), shift operating device 8 and various components of the ECU 100 will be described below.

The engine 1 is a known power source, such as a gasoline engine or a diesel engine, that outputs power by burning fuel, and is configured to control an operating state, such as a throttle opening degree (intake air amount), a fuel injection amount, and an ignition timing. The rotational speed of a crankshaft 11 (engine rotational speed), which is an output shaft of the engine 1, is detected by an engine rotational speed sensor 201. The engine 1 is controlled by the ECU 100.

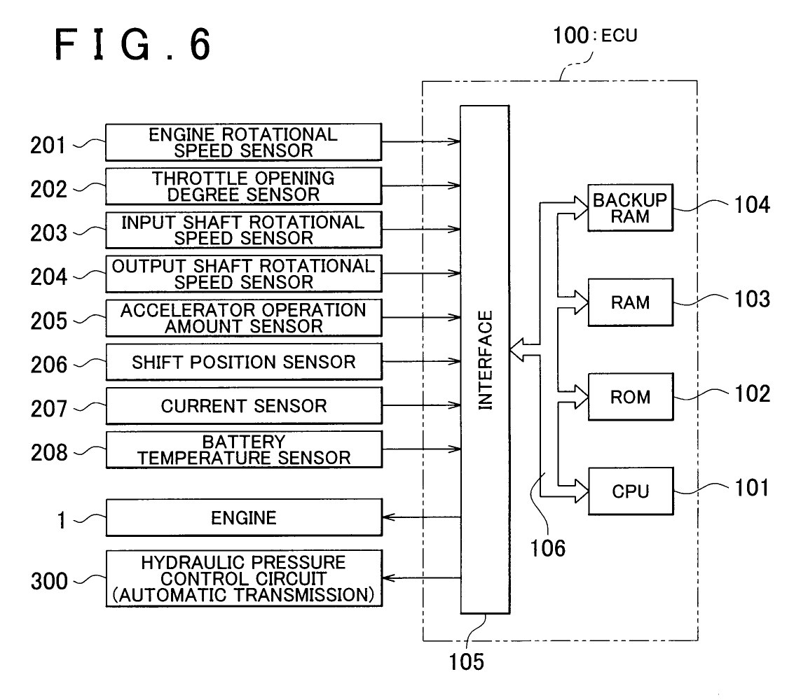

Note that the engine 1 of the present embodiment is equipped with an electronic throttle system that controls the throttle opening degree so as to obtain an optimal intake air amount (target intake air amount) based on an operating state of the engine 1, such as an engine rotational speed and a driver's accelerator operation amount. The above electronic throttle system uses a throttle opening degree sensor 202 (see FIG. 6) to detect an actual throttle opening degree of a throttle valve, and controls an actuator of the throttle valve in a feedback manner so that the actual throttle opening degree coincides with a throttle opening degree (target throttle opening degree) that gives the target intake air amount.

The motor generators MG1 and MG2 are synchronous motors, and not only operate as electric motors but also operate as generators. The motor generators MG1 and MG2 are connected to the battery 5 through the inverter 4. The inverter 4 is controlled by the ECU 100 to set regeneration or power running (assist) of each of the motor generators MG1 and MG2. Then, the battery 5 is charged with regenerated electric power through the inverter 4. In addition, electric power for driving the motor generators MG1 and MG2 is supplied from the battery 5 through the inverter 4.

The power distribution mechanism 2 includes a sun gear S21 which is an external gear, a ring gear R21 which is an internal gear and arranged concentrically with the sun gear S21, a plurality of pinion gears P21 meshed with the sun gear S21 and also meshed with the ring gear R21, and a carrier CA21 that rotatably and revolvably holds the plurality of pinion gears P21. The power distribution mechanism 2 is a planetary gear set that includes these sun gear S21, ring gear R21 and carrier CA21 as rotating elements to perform differential action.

The crankshaft 11 of the engine 1 is connected to the carrier CA21 of the power distribution mechanism 2. In addition, a rotary shaft of the first motor generator MG1 is connected to the sun gear S21 of the power distribution mechanism 2. Then, a ring gear shaft (propeller shaft) 21 is connected to the ring gear R21 of the power distribution mechanism 2. The ring gear shaft 21 is connected through the differential gear 6 to the driving wheels 7. In addition, a rotary shaft of the second motor generator MG2 is connected through the automatic transmission 3 to the ring gear shaft 21.

In the thus structured power distribution mechanism 2, when the first motor generator MG1 operates as a generator, power input from the engine 1 through the carrier CA21 is distributed to the sun gear S21 side and the ring gear R21 side on the basis of their gear ratio. On the other hand, when the first motor generator MG1 operates as an electric motor, power input from the engine 1 through the carrier CA21 and power input from the first motor generator MG1 through the sun gear S21 are integrated and output to the ring gear R21.

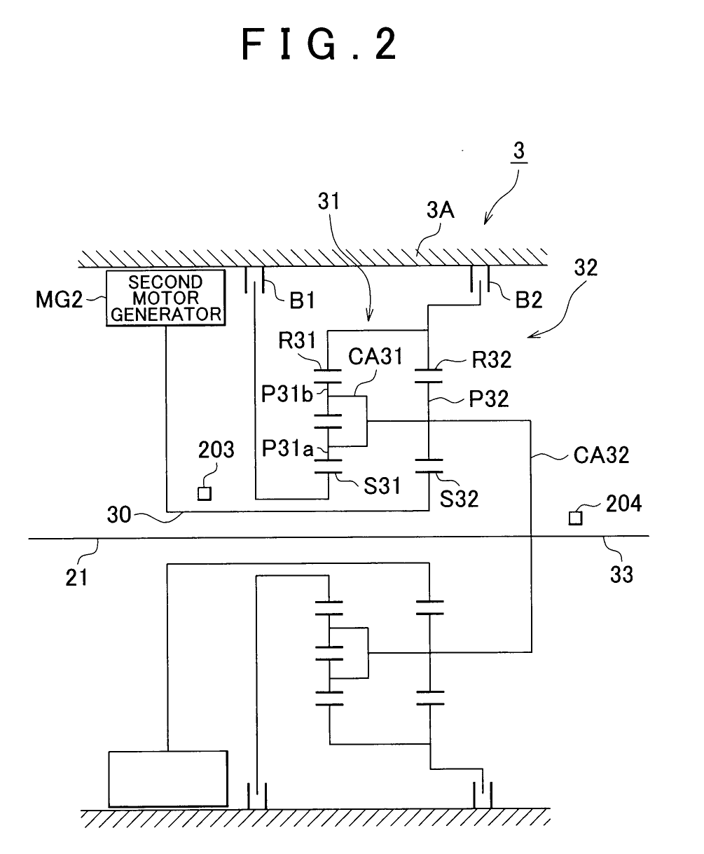

As shown in FIG. 2, the automatic transmission 3 is a planetary gear transmission that includes a double pinion type first planetary gear set 31, a single pinion type second planetary gear set 32, two brakes B1 and B2, and the like, and an input shaft 30 of the automatic transmission 3 is connected to the rotary shaft of the second motor generator MG2. In addition, an output shaft 33 of the automatic transmission 3 is connected to the ring gear shaft 21 (FIG. 1).

The first planetary gear set 31 includes a sun gear S31 which is an external gear, a ring gear R31 which is an internal gear and arranged concentrically with the sun gear S31, a plurality of first pinion gears P31a meshed with the sun gear S31, a plurality of second pinion gears P31b meshed with the first pinion gears P31a and also meshed with the ring gear R31, and a carrier CA31 that couples and rotatably and revolvably holds these plurality of first pinion gears P31a and plurality of second pinion gears P31b. The carrier CA31 of the first planetary gear set 31 is integrally connected to a carrier CA32 of the second planetary gear set 32. Then, the sun gear S31 of the first planetary gear set 31 is selectively connected through the brake B1 to a housing 3A, which is a non-rotating member, and rotation of the sun gear S31 is blocked by engaging the brake B1.

The second planetary gear set 32 includes a sun gear S32 which is an external gear, a ring gear R32 which is an internal gear and arranged concentrically with the sun gear S32, a plurality of pinion gears P32 meshed with the sun gear S32 and also meshed with the ring gear R32, and the carrier CA32 that rotatably and revolvably holds the plurality of pinion gears P32. The sun gear S32 of the second planetary gear set 32 is connected to the input shaft 30, and the carrier CA32 is connected to the output shaft 33. Furthermore, the ring gear R32 of the second planetary gear set 32 is selectively connected through the brake B2 to the housing 3A, and rotation of the ring gear R32 is blocked by engaging the brake B2.

Then, the rotational speed of the input shaft 30 (input shaft rotational speed) of the automatic transmission 3 is detected by an input shaft rotational speed sensor 203. In addition, the rotational speed of the output shaft 33 of the automatic transmission 3 (output shaft rotational speed) is detected by an output shaft rotational speed sensor 204. A current gear of the automatic transmission 3 may be determined on the basis of a ratio of the rotational speeds obtained from signals output from these input shaft rotational speed sensor 203 and output shaft rotational speed sensor 204 (output shaft rotational speed/input shaft rotational speed).

The automatic transmission 3 may be shifted to, for example, P range (parking), N range (neutral range), D range (forward running range), and the like, when the driver operates a shift lever 81 (see FIG. 5A and FIG. 5B) of the shift operating device 8.

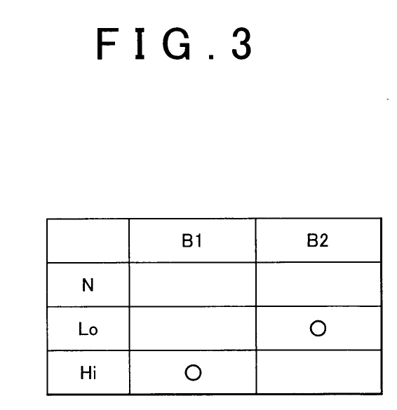

In the above described automatic transmission 3, the brakes B1 and B2, which are frictional engagement elements, are engaged or released in a predetermined state, thus setting a gear. Engaged or released states of the brakes B1 and B2 of the automatic transmission 3 are shown in the operation table of FIG. 3. In the operation table of FIG. 3, “circle” represents “engaged”, and “blank” represents “released”.

In the automatic transmission 3 of this embodiment, by releasing both the brakes B1 and B2, the input shaft 30 (rotary shaft of the second motor generator MG2) may be disconnected from the output shaft 33 (ring gear shaft 21) (neutral state).

In addition, a gear “Lo” is set so that the brake B2 is engaged and the brake B1 is released. When the brake B2 is engaged, the ring gear R32 of the second planetary gear set 32 is fixed and does not rotate. Then, the fixed ring gear R32 and the sun gear S32 rotated by the second motor generator MG2 cooperate to rotate the carrier CA32, that is, the output shaft 33, at a low rotational speed.

A gear “Hi” is set so that the brake B1 is engaged and the brake B2 is released. When the brake B1 is engaged, the sun gear S31 of the first planetary gear set 31 is fixed and does not rotate. Then, the fixed sun gear S31 and the sun gear S32 (ring gear R31) rotated by the second motor generator MG2 cooperate to rotate the carrier CA32 (carrier CA31), that is, the output shaft 33, at a high rotational speed.

In the above described automatic transmission 3, upshifting from “Lo” to “Hi” is achieved by the clutch-to-clutch shift control in which the brake B2 is released while the brake B1 is engaged at the same time. In addition, downshifting from “Hi” to “Lo” is achieved by the clutch-to-clutch shift control in which the brake B1 is released while the brake B2 is engaged at the same time. Hydraulic pressures of these brakes B1 and B2 during engagement or release are controlled by the hydraulic pressure control circuit 300 (see FIG. 4).

The hydraulic pressure control circuit 300 includes linear solenoid valves, control valves, and the like, which will be described later. It is possible to control engagement/release of each of the brakes B1 and B2 of the automatic transmission 3 in such a manner that hydraulic circuits are switched by controlling excitation/de-excitation of each of the solenoid valves. Excitation/de-excitation of each of the linear solenoid valves of the hydraulic pressure control circuit 300 is controlled by a solenoid control signal (hydraulic pressure command signal) from the ECU 100.

FIG. 4 shows a schematic configuration of the hydraulic pressure control circuit 300. As shown in FIG. 4, the hydraulic pressure control circuit 300 includes a mechanical pump MP that is driven by rotation of the engine 1 to feed oil (automatic transmission fluid: ATF) into an oil flow passage 301 under pressure that is sufficient to actuate the brakes B1 and B2; a three-way solenoid valve 302 and a pressure control valve 303 that adjust a line hydraulic pressure PL of the oil fed from the mechanical pump MP to the oil flow passage 301; linear solenoid valves 304 and 305, control valves 306 and 307, and accumulators 308 and 309, which use the line hydraulic pressure PL to adjust engaging forces of the brakes B1 and B2.

In the hydraulic pressure control circuit 300, the line hydraulic pressure PL may be adjusted by actuating the three-way solenoid valve 302 to control opening/closing of the pressure control valve 303.

In addition, the engaging force of each of the brakes B1 and B2 may be adjusted in such a manner that an electric current supplied to a corresponding one of the linear solenoid valves 304 and 305 is controlled to control opening/closing of a corresponding one of the control valves 306 and 307 that transmit the line hydraulic pressure PL to the brakes B1 and B2.

Note that in the hydraulic pressure control circuit 300, redundant oil that is not used for actuating the brakes B1 and B2 within the oil fed under pressure from the mechanical pump MP and oil returned from the pressure control valve 303 after being used for actuating the brakes B1 and B2 are supplied as lubricant oil through the oil flow passage 310 to the power distribution mechanism 2, and the like.

On the other hand, the shift operating device 8, as shown in FIG. 5A and FIG. 5B, is arranged near a driver's seat of the hybrid vehicle HV The shift lever 81 is changeably provided for the shift operating device 8.

The shift operating device 8 of the present embodiment has P (parking) position, R (reverse) position, N (neutral) position, and D (drive) position, and allows the driver to change the shift lever 81 to a desired position. The positions of these P position, R position, N position, and D position (including the following upshift (+) position and downshift (−) position of the S position) are detected by a shift position sensor 206 (see FIG. 6).

The P position and the N position are non-running positions that are selected when the vehicle is parked or stopped, and the R position and the D position are running positions that are selected when the vehicle runs.

In addition, as shown in FIG. 5B, the shift operating device 8 has an S (sequential) position 82. When the shift lever 81 is operated to the S position 82, a sequential mode (manual shift mode) is set to allow manual shifting.

In this embodiment, for example, six sequential shift ranges S1 to S6 are set. When the shift lever 81 is operated to an upshift (+) position or a downshift (−) position, the sequential shift range upshifts or downshifts. For example, every time the shift lever 81 is operated to the upshift (+) position, the sequential shift range upshifts range by range (for example, S1→S2→ . . . →S6). On the other hand, every time the shift lever 81 is operated to the downshift (−) position, the sequential shift range downshifts range by range (for example, S6→S5→ . . . →S1). Note that a shift range control in the sequential mode will be described later.

As shown in FIG. 6, the ECU 100 includes a CPU 101, a ROM 102, a RAM 103, a backup RAM 104, and the like.

The ROM 102 stores various programs including a program for executing a shift control that sets the gear of the automatic transmission 3 on the basis of a running state of the hybrid vehicle HV in addition to a control related to basic driving of the hybrid vehicle HV. The shift control will be specifically described later.

The CPU 101 executes arithmetic processing on the basis of various control programs and maps, which are stored in the ROM 102. In addition, the RAM 103 is a memory that temporarily stores processing results in the CPU 101 and data, and the like, input from the sensors. The backup RAM 104 is a nonvolatile memory that stores data, and the like, that should be saved when the engine 1 is stopped.

These CPU 101, ROM 102, RAM 103 and backup RAM 104 are connected one another through a bus 106, and are further connected to an interface 105.

The interface 105 of the ECU 100 is connected to the engine rotational speed sensor 201, the throttle opening degree sensor 202 that detects the opening degree of the throttle valve of the engine 1, the input shaft rotational speed sensor 203, the output shaft rotational speed sensor 204, an accelerator operation amount sensor 205 that detects an amount by which the accelerator pedal is depressed, the shift position sensor 206 that detects the position of the shift lever 81, a current sensor 207 that detects a current that is charged into or discharged from the battery 5, a battery temperature sensor 208, and the like. Signals from these sensors are input to the ECU 100.

The ECU 100 executes various controls of the engine 1, including a throttle opening degree (intake air amount) control, a fuel injection amount control, an ignition timing control, and the like, of the engine 1 on the basis of signals output from the above described various sensors.

The ECU 100 outputs a solenoid control signal (hydraulic pressure command signal) to the hydraulic pressure control circuit 300 of the automatic transmission 3. On the basis of the solenoid control signal, the linear solenoid valves, and the like, of the hydraulic pressure control circuit 300 are controlled, and the brakes B1 and B2 are engaged or released into a predetermined state so as to establish a predetermined gear (Lo or Hi). In addition, in order to manage the battery 5, the ECU 100 calculates a state of charge (SOC) on the basis of an integrated value of charging and discharging electric currents detected by the current sensor 207. Furthermore, the ECU 100 controls the inverter 4 to control regeneration or power running (assist) of each of the first motor generator MG1 and the second motor generator MG2.

Then, the ECU 100 executes the following “shift control”, “shift range control in sequential mode”, “running control” and “engine control before downshifting”.

### Shift Control

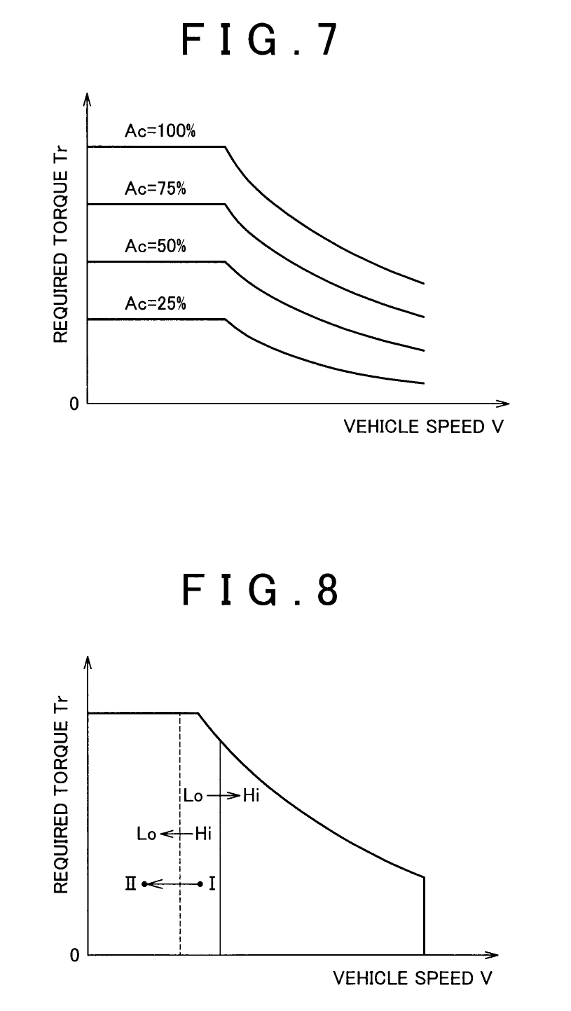

First, the ECU 100 calculates an accelerator operation amount Ac on the basis of a signal output from the accelerator operation amount sensor 205, calculates a vehicle speed V on the basis of a signal output from the output shaft rotational speed sensor 204, and then obtains a required torque Tr with reference to a map shown in FIG. 7 on the basis of the calculated accelerator operation amount Ac and vehicle speed V.

Subsequently, the ECU 100 calculates a target gear with reference to a shift line map shown in FIG. 8 on the basis of the vehicle speed V and the required torque Tr, determines a current gear of the automatic transmission 3 on the basis of a ratio of rotational speeds (output shaft rotational speed/input shaft rotational speed) obtained from signals output from the input shaft rotational speed sensor 203 and the output shaft rotational speed sensor 204, and then compares the target gear with the current gear to determine whether it is necessary to shift gears.

When the result of determination indicates that shifting is unnecessary (when the target gear is the same as the current gear and the gear is appropriately set), the ECU 100 outputs a solenoid control signal (hydraulic pressure command signal) for maintaining the current gear to the hydraulic pressure control circuit 300 of the automatic transmission 3.

On the other hand, when the target gear is different from the current gear, a shift control will be executed. For example, when the running state of the hybrid vehicle HV changes (for example, the vehicle speed changes) from the situation in which the hybrid vehicle HV is running in a state where the gear of the automatic transmission 3 is “Hi” and, for example, changes from point I to point II shown in FIG. 8, the target gear obtained from the shift line map is “Lo”. Then, the ECU 100 outputs a solenoid control signal (hydraulic pressure command signal) for setting the “Lo” gear to the hydraulic pressure control circuit 300 of the automatic transmission 3 to release the brake B1 (frictional engagement element) while engaging the brake B2 (frictional engagement element). Thus, the gear is shifted from the Hi gear to the Lo gear (Hi→Lo downshift).

The map for calculating a required torque, shown in FIG. 7, uses a vehicle speed V and an accelerator operation amount Ac as parameters, and is formed using required torques Tr that are empirically obtained through experiments, calculation, and the like. The map is stored in the ROM 102 of the ECU 100.

In addition, the shift line map shown in FIG. 8 uses a vehicle speed V and a required torque Tr as parameters. Two regions (Lo region and Hi region) are set in the shift line map for calculating an appropriate gear on the basis of those vehicle speed V and required torque Tr. The shift line map is stored in the ROM 102 of the ECU 100. In the shift line map shown in FIG. 8, an upshift line (shift line) is indicated by the solid lines, and a downshift line (shift line) is indicated by the broken lines. In addition, shift directions of an upshift and a downshift are indicated using arrows in the drawing.

Note that in a state where the sequential mode is selected as well, when the running state of the hybrid vehicle HV changes to cross the upshift line or downshift line of the shift line map shown in FIG. 8, the ECU 100 downshifts or upshifts the automatic transmission 3.

### Shift Range Control in Sequential Mode

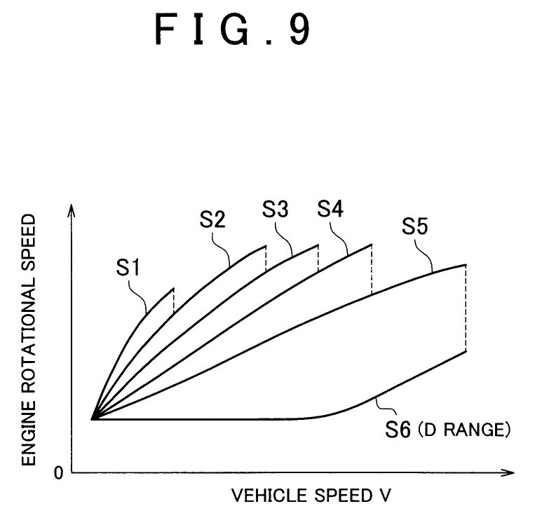

The ECU 100 calculates a vehicle speed V on the basis of a signal output from the output shaft rotational speed sensor 204, and determines a lower limit engine rotational speed on the basis of the calculated vehicle speed V. Specifically, for example, as shown in FIG. 9, using a map in which the engine rotational speed is set for each of the sequential shift ranges S1 to S6 with a vehicle speed (output shaft rotational speed) V as a parameter, the ECU 100 determines a lower limit engine rotational speed with reference to the map shown in FIG. 9 on the basis of the current vehicle speed V and the positional information of the sequential shift range S1 to S6 selected by operating the shift lever, and then controls the operating state of the first motor generator MG1, which is coupled to the power distribution mechanism 2, so that the engine rotational speed is higher than or equal to the lower limit engine rotational speed.

Note that the map shown in FIG. 9 is stored in the ROM 102 of the ECU 100. In addition, in the map shown in FIG. 9, when the vehicle speed V is the same, the sequential shift range S1 has the highest engine rotational speed, and the engine rotational speed sequentially decreases toward the sequential shift range S6. For example, when the sequential shift range is operated to downshift from “S3” to “S2”, the engine rotational speed increases. On the other hand, when the sequential shift range is operated to upshift from “S3” to “S4”, the engine rotational speed decreases.

### Running Control

The ECU 100, as in the case of the above process, calculates a required torque Tr that should be output to the ring gear shaft (propeller shaft) 21 with reference to the map shown in FIG. 7 on the basis of the accelerator operation amount Ac and the vehicle speed V, and controls the engine 1 and the motor generators MG1 and MG2 (inverter 4) so that a required power corresponding to the required torque Tr is output to the ring gear shaft 21, thus causing the hybrid vehicle HV to run in a predetermined running mode.

For example, in a range in which the efficiency of the engine is low, such as at startup or during low-speed running, the operation of the engine 1 is stopped, and a power corresponding to a required power is output from the second motor generator MG2 through the automatic transmission 3 to the ring gear shaft 21. During normal running, the engine 1 is driven so that a power corresponding to a required power is output from the engine 1, and the rotational speed of the engine 1 is controlled to provide an optimal fuel efficiency using the first motor generator MG1.

In addition, when the second motor generator MG2 is driven to assist torque, the gear of the automatic transmission 3 is set to “Lo” to increase torque added to the ring gear shaft (propeller shaft) 21 in a state where the vehicle speed V is low, while the gear of the automatic transmission 3 is set to “Hi” to relatively decrease the rotational speed of the second motor generator MG2 to thereby reduce a loss in a state where the vehicle speed V is high. Thus, torque assist is efficiently performed. Furthermore, another running control is also executed such that the operation of the second motor generator MG2 is stopped, the first motor generator MG1 provides counter force against engine torque, and the hybrid vehicle HV runs only by torque (directly transmitted torque) that is directly transmitted from the engine 1 through the power distribution mechanism 2 to the ring gear shaft 21.

Note that the ECU 100 normally supplies constant-power command to the second motor generator MG2 to control the second motor generator MG2 so that an input torque to the automatic transmission 3 generates a constant power (input shaft rotational speed×input torque=constant).

### Engine Control During Downshifting (1)

First, in the hybrid vehicle HV, when the accelerator pedal is depressed during downshifting (during power-on downshifting), it is necessary to reduce the torque of the second motor generator MG2 during shifting in order to reduce shift shock and to reduce a thermal load on the friction material of the frictional engagement element (brake B2) of the automatic transmission 3. However, as described above, when the engine 1 is rotated at a high speed, a protection control (engine overrun prevention control) is activated and, as a result, the torque cannot be reduced. That is, when the engine rotational speed is low, an engine power may be consumed by increasing the engine rotational speed. However, when the engine rotational speed is high, such as when the above described sequential shift is used, a rotational speed control is executed in the first motor generator MG1 that provides counter force against engine torque for preventing the engine 1 from overrunning (components protection). Thus, the amount of electric power generated by (power generation amount of) the first motor generator MG1 increases. As the power generation amount increases in this way, the second motor generator MG2 is required to consume electric power and, therefore, cannot reduce the torque desirably.

Then, when the torque cannot be reduced during downshifting because of the above reason, an increase in rotational speed of the second motor generator MG2, which is associated with gear shifting, cannot be restricted. This may cause engagement shock. In addition, a thermal load on the friction material of the frictional engagement element may increase.

In consideration of the above, in the present embodiment, during downshifting (Hi→Lo gear shift), a power output from the engine 1 is restricted so that electric power balance is maintained between the first motor generator MG1 and the second motor generator MG2. Thus, the torque of the second motor generator MG2 may be reduced.

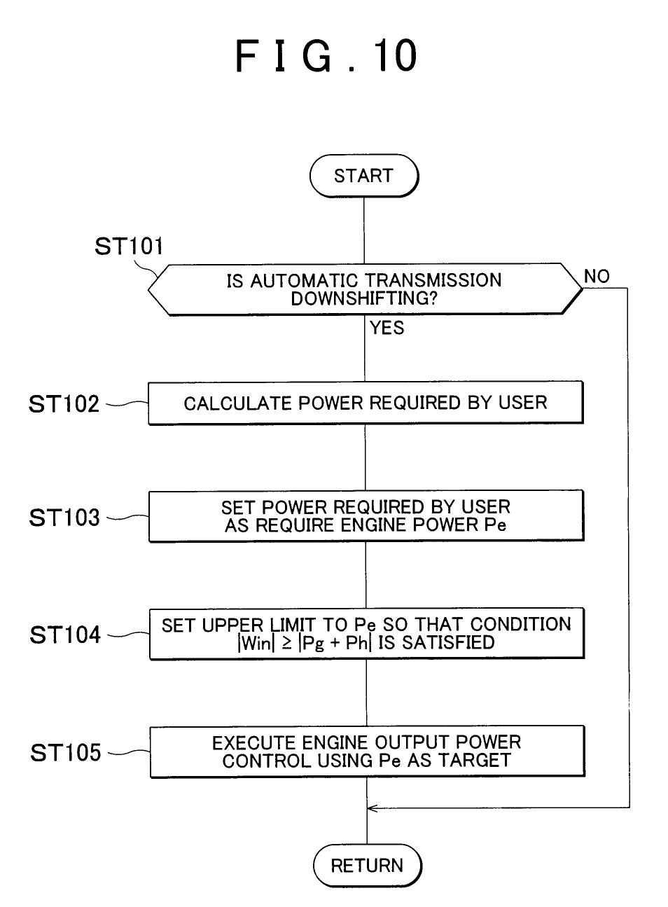

A specific example of the control will be described with reference to the flowchart shown in FIG. 10. The control routine shown in FIG. 10 is repeatedly executed at predetermined time intervals (for example, several msec) in the ECU 100.

In step ST101, it is determined whether the automatic transmission 3 is downshifting (Hi→Lo gear shift). When the result of determination is affirmative, the process proceeds to step ST102. When the result of determination in step ST101 is negative (when the automatic transmission 3 is not downshifting), the process returns.

In step ST102, a power required by the user is calculated. Specifically, as in the case of the above process, a required torque Tr is calculated with reference to the map shown in FIG. 7 on the basis of the accelerator operation amount Ac and the vehicle speed V, and the power required by the user is calculated from the required torque Tr and the output shaft rotational speed (which is calculated on the basis of a signal output from the output shaft rotational speed sensor 204) (required power=required torque×output shaft rotational speed). The thus calculated power required by the user is set as a required engine power Pe (step ST103).

In step ST104, a current electric power acceptance limit Win of the battery 5 is calculated on the basis of the battery temperature detected by the battery temperature sensor 208 and the SOC, and an upper limit of an output of the engine 1 (engine power Pe) is set so that the following electric power balance maintaining condition is satisfied.

|Win|≧|Pg+Ph|

where Pg denotes the amount of electric power generated by the first motor generator MG1 (the power generation amount of the first motor generator MG1) that controls the engine rotational speed, and Ph denotes the amount of electric power consumed by auxiliary machines (auxiliary machine consuming power). The auxiliary machine consuming power Ph is set in consideration of feedback margin, the amount of electric power consumed by the engine (engine consuming power) (inertia, torque reduction), a power loss, and the like.

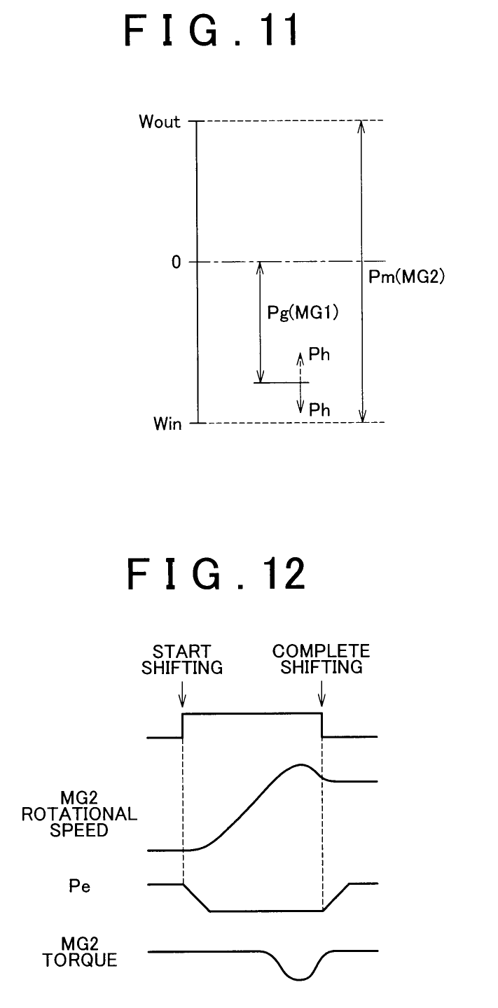

Pg (power generation amount of MG1) in the above electric power balance maintaining condition is electric power input to the battery 5, so it takes a negative value with respect to the battery 5 as shown in FIG. 11. Then, when Pg satisfies the electric power balance maintaining condition (|Win|≧|Pg+Ph|), as shown in FIG. 11, the second motor generator MG2 may be used between Win and Wout (electric power output limits). Thus, it is possible to reduce the torque of the second motor generator MG2.

In addition, among the parameters of the auxiliary machine consuming power Ph, the feedback margin is a value in consideration of variations, or the like, of the engine rotational speed and may be a negative or positive value depending on the condition in which the auxiliary machine consuming power Ph is applied. In addition, among the parameters of the auxiliary machine consuming power Ph, the engine consuming power and the power loss are positive values. As power output from the engine decreases by controlling the engine 1 (output power restriction), the power generation amount of the first motor generator MG1 reduces. Thus, the torque reduction portion of the engine consuming power is a parameter for reflecting that reduced power and is a positive value. Note that the auxiliary machine consuming power Ph may be a negative or positive value depending on whether the feedback margin is positive or negative (see FIG. 11). In addition, the auxiliary machine consuming power Ph is set to a value (fixed value) that is empirically obtained beforehand through experiments, calculation, or the like.

Then, in step ST105, an output power control on the engine 1 (engine output power restriction control) is executed using the required engine power Pe, of which the upper limit is set in step ST104, as a target output power.

As described above, according to the control of the present embodiment, the upper limit of an output power from the engine 1 is set so as to satisfy the condition that the sum (|Pg+Ph|) of the power generation amount Pg of the first motor generator MG1 and the auxiliary machine consuming power Ph falls within the battery acceptance limit Win. Thus, even when the torque of the second motor generator MG2 is reduced during downshifting, it is possible to maintain the electric power balance between the first motor generator MG1 and the second motor generator MG2.

Thus, even when the engine is rotated at a high speed while the sequential shift is used, or the like, the engine output power restriction control allows the torque of the second motor generator MG2 to reduce. Hence, it is possible to suppress an increase in rotational speed of the second motor generator MG2. By so doing, it is possible to reduce a difference between the rotational speed of the second motor generator MG2 and the engaging target rotational speed (synchronous rotational speed of a target gear) when the frictional engagement element is engaged. Thus, shift shock may be suppressed, and the friction material of the frictional engagement element (brake B2) of the automatic transmission 3 may be protected.

Here, in the control of the present embodiment, when the engine output power control is executed, as shown in FIG. 12, the engine output power (engine power Pe) is gradually varied at the time when output power restriction is started and completed. Thus, it is possible to suppress occurrence of shift shock at the time when a engine output power varies.

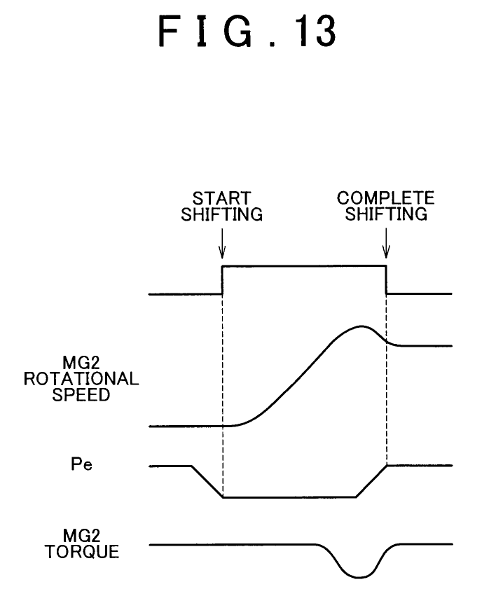

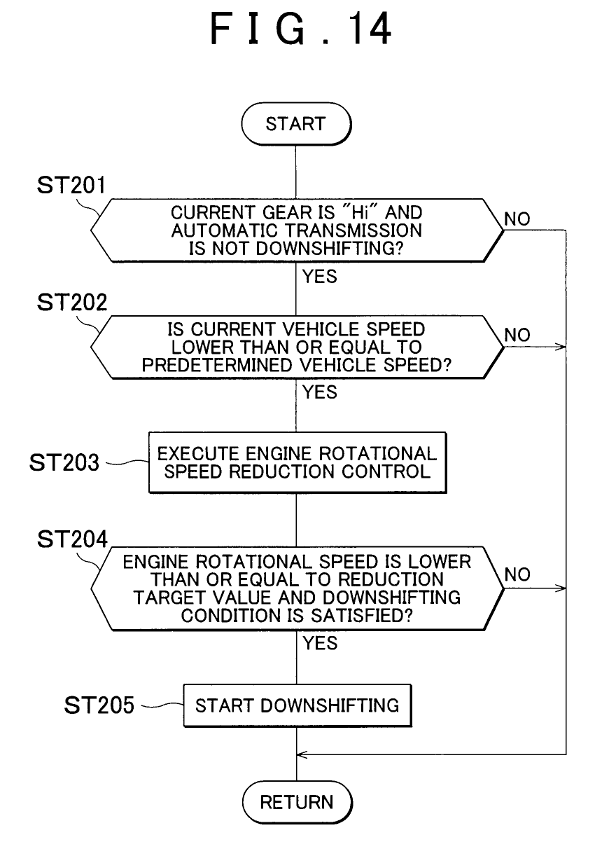

In addition, the engine output power restriction may be started at the time when the operating state of the hybrid vehicle HV (vehicle speed, and the like) approaches the downshift line (shift line) shown in FIG. 8 (before shifting), and the engine output power (engine power Pe) may be gradually varied from that time (see FIG. 13). In addition, similarly, cancellation of the engine output power control may be executed when shifting is not complete (during shifting) by checking the progress of shifting (see FIG. 13).

Engine Control before Downshifting

As described above, in the hybrid vehicle HV, it is necessary to reduce the torque of the second motor generator MG2 during downshifting; however, when the engine rotational speed is high, such as when the sequential shift is used, the torque cannot be reduced because a protection control (engine overrun prevention control) is activated in the first motor generator MG1. In addition, when it takes long time until shifting is complete, such as when the automatic transmission 3 downshifts at a high vehicle speed, the torque of the second motor generator MG2 cannot be reduced.

Then, when the torque cannot be reduced during downshifting because of the above reason, an increase in rotational speed of the second motor generator MG2, which is associated with gear shifting, cannot be restricted. This may cause engagement shock. In addition, a thermal load on the friction material of the frictional engagement element may increase.

In consideration of the above, in the present embodiment, when the engine rotational speed is high, such as when the sequential shift is used, the engine rotational speed is decreased before downshifting (Hi→Lo gear shift), and, after the engine rotational speed is decreased to a rotational speed at which the protection control is not activated, the automatic transmission 3 starts downshifting.

A specific example of the control will be described with reference to the flowchart shown in FIG. 14. The control routine shown in FIG. 14 is repeatedly executed at predetermined time intervals (for example, several msec) in the ECU 100.

In step ST201, it is determined whether the current gear is “Hi” and the automatic transmission 3 is not downshifting. When the result of determination is affirmative, the process proceeds to step ST202. When the result of determination in step ST201 is negative (the current gear is “Lo” or the automatic transmission 3 is downshifting), the process returns.

In step ST202, it is determined whether the current vehicle speed V calculated from a signal output from the output shaft rotational speed sensor 204 is smaller than or equal to a predetermined vehicle speed. Specifically, it is determined whether the current vehicle speed V is smaller than or equal to a predetermined vehicle speed (for example, a predetermined vehicle speed=vehicle speed at the downshift line+5 km/h) before the downshift line (on the high-speed side) in the shift line map shown in FIG. 8. When the result of determination is affirmative, the process proceeds to step ST203. When the result of determination in step ST202 is negative, the process returns.

In step ST203, the rotational speed of the engine 1 is decreased. A method of decreasing the engine rotational speed may be a method of decreasing a target rotational speed of the first motor generator MG1 or a method of decreasing a target rotational speed of the engine 1. For example, at the time of power on (when the accelerator pedal is depressed) or at the time of power off (when the accelerator pedal is not depressed), the target rotational speed of the engine 1 is decreased to decrease the engine rotational speed. In addition, at the time of power off (when the accelerator pedal is not depressed) and during fuel cut-off of the engine 1, the target rotational speed of the first motor generator MG 1 is decreased to decrease the engine rotational speed.

In step ST204, it is determined whether the engine rotational speed obtained from a signal output from the engine rotational speed sensor 201 is smaller than or equal to a reduction target value, and it is also determined whether a downshifting condition is satisfied. When the engine rotational speed is smaller than or equal to the reduction target value (engine rotational speed:reduction target value), and when the downshifting condition is satisfied (when the result of determination in step ST204 is affirmative), the process proceeds to step ST205 and starts downshifting. On the other hand, the result of determination in step ST204 is negative, the process returns.

Note that in the determination process in step ST204, when the running state of the hybrid vehicle HV changes (decrease in vehicle speed V, or the like) to cross the downshift line (Hi→Lo) of the shift line map shown in FIG. 8, it is determined that the downshifting condition is satisfied.

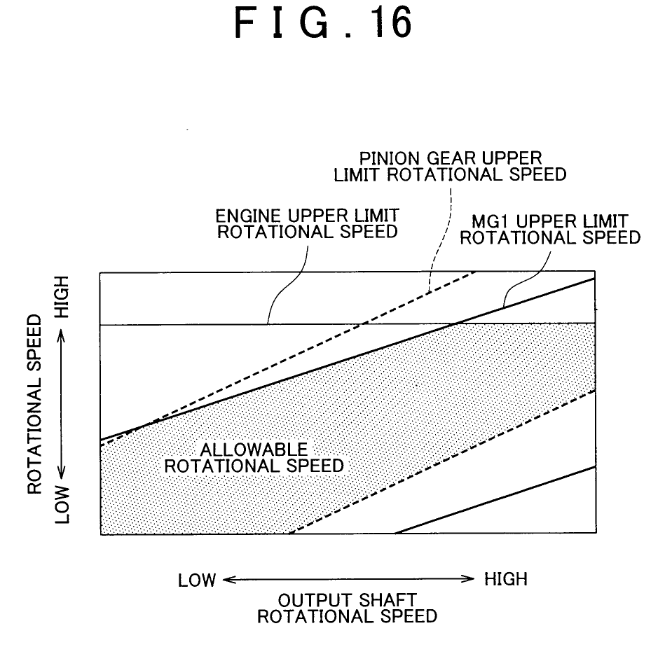

Here, in step ST204, the reduction target value set for the engine rotational speed will be described. First, in the hybrid vehicle HV, for example, as shown in FIG. 16, the allowable rotational speed of the engine 1 is determined in order to protect the engine 1 and to protect the pinion gears P21 and the first motor generator MG1, and the engine rotational speed is controlled (protection control) by the first motor generator MG1 so as not to exceed the upper limit value of the allowable rotational speed. Thus, the reduction target value is set in consideration of a rotational speed at which the protection control (engine overrun prevention control) is not activated. Note that the reduction target value is, for example, set to 1200 rpm when the battery 5 cannot accept electric power. In addition, the reduction target value may be set variably in consideration of a state in which the battery 5 accepts electric power as described above.

As described above, according to the control of the present embodiment, the engine rotational speed is decreased before downshifting, and, after the engine rotational speed is decreased to a rotational speed at which the protection control is not activated in the first motor generator MG1 (after the engine rotational speed is smaller than or equal to the reduction target value), the automatic transmission 3 downshifts. Thus, the torque of the second motor generator MG2 may be reduced during downshifting. By so doing, shift shock may be suppressed, and the friction material of the frictional engagement element (brake B2) may be protected.

Note that in the present embodiment, because the protection control is not activated during downshifting, during sporty running, or the like, using the sequential shift, the downshift line (see FIG. 8) is shifted to a higher vehicle speed side to increase a “Lo” running range. Thus, it is possible to downshift at a high vehicle speed, and it is possible to prevent overheating of the second motor generator MG2.

### Engine Control During Downshifting (2)

As described above, in the hybrid vehicle HV, it is necessary to reduce the torque of the second motor generator MG2 during downshifting; however, when the engine rotational speed is high, such as when the sequential shift is used, the torque cannot be reduced because a protection control (engine overrun prevention control) is activated in the first motor generator MG1. Then, when the torque cannot be reduced during downshifting because of the above reason, an increase in rotational speed of the second motor generator MG2, which is associated with gear shifting, cannot be restricted. This may cause engagement shock. In addition, a thermal load on the friction material of the frictional engagement element may increase.

If an increase in engine rotational speed may be suppressed, there is no problem. However, when the increase in rotational speed is suppressed by torque restriction using the electronic throttle system, because the response is poor (normally, because a moderating process, or the like, is executed), the engine rotational speed control cannot make in time. In addition, it is also conceivable that an increase in engine rotational speed is suppressed by fuel cut-off of the engine 1. However, in this case, it is necessary to hold the engine rotational speed by the first motor generator MG1 and, therefore, shift shock due to excessive discharging or steep variation in torque may occur.

In consideration of the above, in the present embodiment, during downshifting (Hi→Lo gear shift), a rate of increase in engine rotational speed is suppressed by a control on the engine, such as an ignition timing retardation control or a fuel injection amount reduction control. Thus, the torque of the second motor generator MG2 may be reduced.

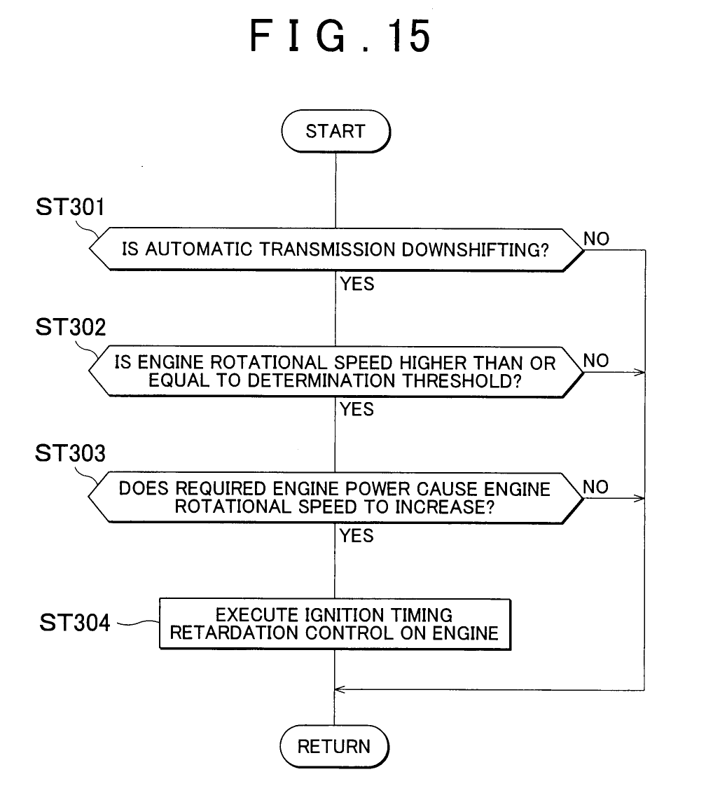

A specific example of the control will be described with reference to the flowchart shown in FIG. 15. The control routine shown in FIG. 15 is repeatedly executed at predetermined time intervals (for example, several msec) in the ECU 100.

In step ST301, it is determined whether the automatic transmission 3 is downshifting (Hi→Lo gear shift). When the result of determination is affirmative, the process proceeds to step ST302. When the result of determination in step ST301 is negative (when the automatic transmission 3 is not downshifting), the process returns.

In step ST302, it is determined whether the engine rotational speed obtained from a signal output from the engine rotational speed sensor 201 is larger than or equal to a determination threshold. When the result of determination in step ST302 is affirmative (when the engine rotational speed is higher than or equal to the determination threshold), the process proceeds to step ST303. When the result of determination in step ST302 is negative (when the engine rotational speed is lower than the determination threshold), the process returns.

Here, the determination threshold set for the engine rotational speed is determined in consideration of the upper limit rotational speed of the engine 1, the upper limit rotational speed of a rotating element (for example, the pinion gears P21 of the power distribution mechanism 2) of the driving force transmission system, the upper limit rotational speed of the first motor generator MG1, and the like. Specifically, in the hybrid vehicle HV, for example, as shown in FIG. 16, the allowable rotational speed of the engine 1 is determined in order to protect the engine 1 and to protect the pinion gears P21 and the first motor generator MG1, and the engine rotational speed is controlled (protection control) by the first motor generator MG1 so as not to exceed the upper limit value of the allowable rotational speed. Thus, the determination threshold is set to a value that allows a margin for the upper limit value of the allowable rotational speed (allowable rotational speed upper limit value—margin). In addition, the determination threshold may be set variably in consideration of a state in which the battery 5 accepts electric power as described above.

In step ST303, a required engine power Pe is obtained as in the case of the above process (process in step ST103 in FIG. 10), and it is determined whether the required engine power Pe causes the engine rotational speed to increase. Specifically, it is determined whether the required engine power is large and, therefore, the engine rotational speed increases during downshifting to reach the upper limit allowable rotational speed (the engine rotational speed reaches the upper limit) shown in FIG. 16. When the result of determination is affirmative, the process proceeds to step ST304. When the result of determination in step ST303 is negative, the process returns.

Then, in step ST304, the ignition timing retardation control is executed on the engine 1 to suppress a rate of increase in engine rotational speed. By suppressing a rate of increase in engine rotational speed in this way, the protection control by the first motor generator MG1 is not activated during downshifting and, therefore, the torque of the second motor generator MG2 may be reduced. By so doing, shift shock may be suppressed and, therefore, it is possible to protect the friction material of the frictional engagement element (brake B2).

Note that in the control shown in FIG. 15, a rate of increase in engine rotational speed is suppressed by the ignition timing retardation control on the engine 1; however, it is not limited. Instead, a rate of increase in engine rotational speed may be suppressed by the fuel injection amount reduction control on the engine 1 or a control for canceling a moderating process on torque restriction in the electronic throttle control. In addition, a rate of increase in engine rotational speed may be suppressed by a combination of any two or all of these ignition timing retardation control on the engine 1, the fuel injection amount reduction control on the engine 1, and the control for canceling a moderating process on torque restriction in the electronic throttle control.

### Alternative Embodiments

In the above described embodiment, the aspects of the invention are applied to a control for a vehicle equipped with a forward two-gear automatic transmission; however, the aspects of the invention are not limited to it. Instead, the aspects of the invention may be, for example, applied to a control for a vehicle equipped with a planetary gear automatic transmission having other selected number of gears, such as forward four gears.

In the above embodiment, the aspects of the invention are applied to a control for a vehicle equipped with a gasoline engine; however, it is not limited. Instead, the aspects of the invention may be applied to a control for a vehicle equipped with another engine, such as a diesel engine. Furthermore, the aspects of the invention are not limited to the FR (front-engine, rear-wheel-drive) vehicle. The aspects of the invention may also be applied to a control for an FF (front-engine, front-wheel-drive) vehicle or a four-wheel drive vehicle.

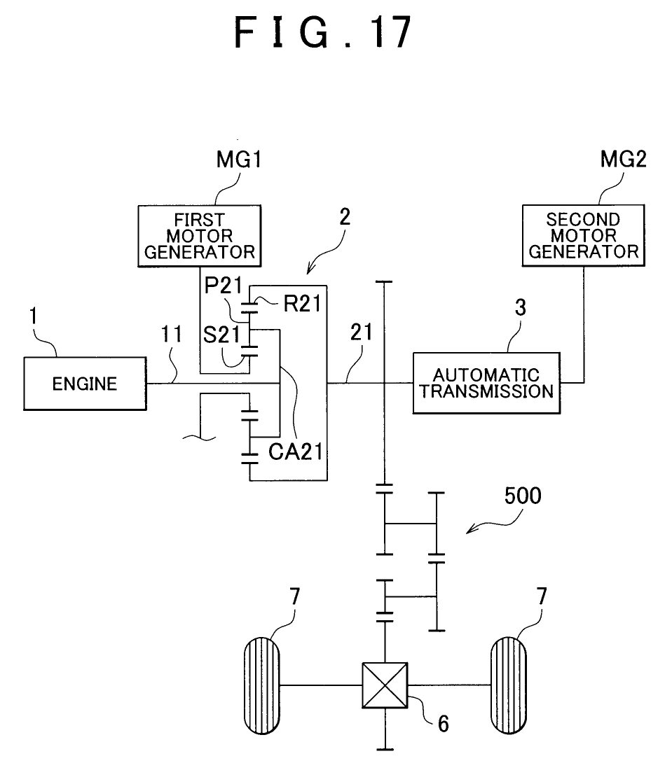

FIG. 17 shows an example of an FF hybrid vehicle.

The hybrid vehicle shown in FIG. 17 includes an engine 1, a first motor generator MG1, a second motor generator MG2, a power distribution mechanism 2, an automatic transmission 3, a gear mechanism 500, a differential gear 6, driving wheels 7, and the like.

In the hybrid vehicle of this embodiment, the rotary shaft of the second motor generator MG2 is connected to the input shaft of the automatic transmission 3. In addition, the output shaft of the automatic transmission 3 is connected to the ring gear shaft 21 of the power distribution mechanism 2, and a power from the second motor generator MG2 is output through the automatic transmission 3, the gear mechanism 500 and the differential gear 6 to the driving wheels 7.

In the hybrid vehicle of this embodiment, the power distribution mechanism 2 has the same structure as that shown in FIG. 1. In addition, the automatic transmission 3 has the same structure as that shown in FIG. 2. Upshifting from “Lo” to “Hi” is achieved by clutch-to-clutch shift control in which the brake B2 is released, while the brake B1 is engaged at the same time. On the other hand, downshifting from “Hi” to “Lo” is achieved by clutch-to-clutch shift control in which the brake B1 is released, while the brake B2 is engaged at the same time.

Then, in the hybrid vehicle shown in FIG. 17 as well, when the torque cannot be reduced during downshifting, an increase in rotational speed of the second motor generator MG2, which is associated with gear shifting, cannot be restricted. This may cause engagement shock. However, in the thus configured hybrid vehicle as well, by executing the control shown in FIG. 10, FIG. 14 or FIG. 15, it is possible to suppress shift shock and protect the friction material of the frictional engagement element (brake B2) of the automatic transmission 3.

The invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A control device for a vehicle that includes:
an engine;
a differential unit that is provided between the engine and driving wheels and that outputs at least portion of power from the engine to the driving wheels;
a first electric motor that is coupled to a rotating element of the differential unit;
a second electric motor;
a step-gear automatic transmission that is provided between the second electric motor and the driving wheels; and
an electric storage device that is able to charge electric power generated by at least one of the first and second electric motors and supply electric power to at least one of the first and second electric motors, the control device comprising:
an engine control unit that restricts an output of the engine so that electric power balance is maintained between the first electric motor and the second electric motor when the automatic transmission is downshifting.

2. The control device for a vehicle according to claim 1, wherein
the engine control unit controls the output of the engine so as to be maximal within a range of the electric power balance.

3. The control device for a vehicle according to claim 1, wherein
the engine control unit gradually changes the output of the engine at the time when the engine control unit starts restricting the output of the engine.

4. The control device for a vehicle according to claim 1, wherein
the engine control unit gradually changes the output of the engine at the time when the engine control unit completes restricting the output of the engine.

5. A control device for a vehicle that includes:
an engine;
a differential unit that is provided between the engine and driving wheels and that outputs at least portion of power from the engine to the driving wheels;
a first electric motor that is coupled to a rotating element of the differential unit;
a second electric motor;
a step-gear automatic transmission that is provided between the second electric motor and the driving wheels; and
an electric storage device that is able to charge electric power generated by at least one of the first and second electric motors and supply electric power to at least one of the first and second electric motors, the control device comprising:
a rotational speed control unit that decreases a rotational speed of the engine before the automatic transmission starts downshifting.

6. The control device for a vehicle according to claim 5, wherein
the rotational speed control unit determines, on the basis of a vehicle speed, whether to start a control for decreasing the rotational speed of the engine.

7. The control device for a vehicle according to claim 5, wherein
the rotational speed control unit causes the automatic transmission to shift a gear when the rotational speed of the engine is lower than or equal to a reduction target value.

8. The control device for a vehicle according to claim 7, wherein
the rotational speed control unit variably sets the reduction target value on the basis of a state in which the electric storage device accepts electric power.

9. A control device for a vehicle that includes:
an engine;
a differential unit that is provided between the engine and driving wheels and that outputs at least portion of power from the engine to the driving wheels;
a first electric motor that is coupled to a rotating element of the differential unit;
a second electric motor;
a step-gear automatic transmission that is provided between the second electric motor and the driving wheels; and
an electric storage device that is able to charge electric power generated by at least one of the first and second electric motors and supply electric power to at least one of the first and second electric motors, the control device comprising:
an engine control unit that suppresses a rate of increase in rotational speed of the engine by a control on the engine when the automatic transmission is downshifting.

10. The control device for a vehicle according to claim 9, wherein
the engine control unit executes a control for suppressing a rate of increase in rotational speed of the engine when the rotational speed of the engine is higher than or equal to a determination threshold.

11. The control device for a vehicle according to claim 9, wherein
the engine control unit executes a control for suppressing a rate of increase in rotational speed of the engine on the basis of an output required for the engine.

12. The control device for a vehicle according to claim 9, wherein
the engine control unit suppresses a rate of increase in rotational speed of the engine by any one or combination of an ignition timing retardation control on the engine, a fuel injection amount reduction control on the engine, or a control for canceling a moderating process on a control of the engine.

13. A control method for a vehicle that includes:
an engine;
a differential unit that is provided between the engine and driving wheels and that outputs at least portion of power from the engine to the driving wheels;
a first electric motor that is coupled to a rotating element of the differential unit;
a second electric motor;
a step-gear automatic transmission that is provided between the second electric motor and the driving wheels; and
an electric storage device that is able to charge electric power generated by at least one of the first and second electric motors and supply electric power to at least one of the first and second electric motors, the control method comprising:
determining whether the automatic transmission is downshifting; and
when it is determined that the automatic transmission is downshifting, restricting an output of the engine so that electric power balance is maintained between the first electric motor and the second electric motor.
